(19) United States
(12) Patent Application Publication
(10) Pub. No.: US 2011/0087679 A1
(43) Pub. Date: Apr. 14, 2011

(54) SYSTEM AND METHOD FOR COHORT BASED CONTENT FILTERING AND DISPLAY

(76) Inventors: Albert Rosato, San Francisco, CA (US); Paul Corning, San Francisco, CA (US)

(21) Appl. No.: 12/902,532

(22) Filed: Oct. 12, 2010

Related U.S. Application Data
(60) Provisional application No. 61/250,925, filed on Oct. 13, 2009.

(51) Int. Cl. G06F 17/30

(52) U.S. Cl. 707/749; 707/E17.005

(57) ABSTRACT

A Cohort based content filtering and display system and method that enable users to obtain near-real-time information about how specific groups of users react to news, products, people, or other items. The system will aggregate and display commercially valuable, near-real-time information about user preferences and attitudes, sorted according to standard demographic and other user categories employed by marketers, research organizations and others, without compromising individual privacy. In some embodiments, a user can select a Cohort of interest to him or her, and then see what is most relevant to that Cohort, even if this user is not a member of the selected Cohort.

### CROSS REFERENCE TO RELATED APPLICATION

This application is based upon and claims benefit of copending and co-owned U.S. Provisional Patent Application Ser. No. 61/250,925 entitled “System and Method for Cohort Based Content Filtering and Display”, filed with the U.S. Patent and Trademark Office on Oct. 13, 2009 by the inventors herein, the specification of which is incorporated herein by reference.

### BACKGROUND

### Field of the Invention

The invention disclosed herein relates generally to a method and system for analyzing various types of users, user behavior and items, and providing recommendations to a user based on the aggregated preferences of specific groups of users, and more particularly to a computer implemented method and system for determining a subjective ranking of a multitude of items, and recommending particular items to a user based upon collaborative filtering methods.

### SUMMARY

It is an object of the present invention to provide a system will make item recommendations to specific users using a combination of item-based and user-based collaborative filtering and content filtering methods that aggregate individual users into any number of statistically significant subgroups, or Cohorts, based on users' demographic, psychographic, group affiliations, or other information.

Another object of the present invention is to provide a system that records and analyzes user behaviors (ratings, user of site content, sharing of site content, etc.) to measure each users' attitudes (‘preferences’) towards specific content items, and aggregates these user preferences by user Cohort to calculate content's relevance for other members of each Cohort.

Another object of the present invention is to provide a system that presents relevance-ranked lists of items to individual users according to users' membership in specific Cohorts, and according to users' interest in seeing items relevant to specific Cohorts other than those of which they are members.

Another object of the present invention is to provide a system that can work with other content filtering/collaborative filtering systems or data sources to establish Cohort item recommendations and Cohort preference data quickly.

Another object of the present invention is to provide a system that will aggregate and display commercially valuable, near-real-time information about user preferences and attitudes, sorted according to standard demographic, psychographic, and other user categories employed by marketers, research organizations and others, without compromising individual privacy.

Another object of the present invention is to provide a system that will reward users for providing relevant information about themselves and agreeing to have that information used to enable useful item recommendations and aggregated preference data.

In accordance with the above and other objects, a cohort based content filtering and display system and method that enables users to obtain near-real-time information about how specific groups of users react to news, products, people, or other items is disclosed. In some embodiments, a user can select a Cohort of interest to him or her and then see what is most relevant to that Cohort, even if this user is not a member of the selected Cohort. In this invention, an “item” is anything that can be presented in a list: news in any form, entertainment media, products, companies, brands, people, and links to any of these.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 shows pictures of an exemplary graphical user interface according to an embodiment of the present invention; and

FIG. 2 shows a flow chart of a collaborative filtering and recommendation system according to an embodiment of the present invention.

### DETAILED DESCRIPTION OF PREFERRED EMBODIMENTS

The invention summarized above may be better understood by referring to the following description, which should be read in conjunction with the accompanying drawings in which like reference numbers are used for like parts. This description of an embodiment, set out below to enable one to practice an implementation of the invention, is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

In the below description of the invention, CollabView is the name of the interactive system for collaborative filtering and recommendations.

### How CollabView Creates Cohorts

CollabView users are grouped into Cohorts according to shared user attributes (relative and absolute parameters), including demographic, behavioral, and other user parameters.
   Relative parameters are user attributes that are easily expressed as points in a linear progression, and so may be easily expressed as values in a linear scale for comparison. They may include user age, geographic distance, income level, level of education attained, activity level, how a user or a user's contributions (comments, blog submissions, photographs, etc.) are rated by other users, etc.
   Absolute parameters are user attributes that are discrete or that are not commonly thought of as being linked on a single linear scale. They may include gender, industry or company affiliation, schools graduated, group affiliation, ethnic background, or other parameters. To incorporate absolute parameters in calculating similarity between users, absolute parameters may be treated as binary conditions, assigned numerical positions in defined value scales, or treated in other ways.
   Relative and absolute parameters may be treated in different ways when calculating user similarity, depending on system optimization requirements, expressed user preferences, business logic, etc.
In general, Cohorts will be defined by identifying users whose specified parameters most closely resemble those of either a specific user or a defined set of user parameters.
Cohorts may be defined by relative user similarity, where the system calculates, relative to a target user, which other users' parameters are, in total, most similar to the target user (e.g., people around 52-years-old, living closest to the 10011 postal code who make close to $50,000 per year); by absolute user similarity (e.g., schoolteachers); by both (the around-52-year-olds must be schoolteachers); and by adjusting these types of similarity for business logic, system limitations, or other factors.
An exemplary formula for calculating relative user similarity is below, where individual difference factors (‘f’) are weighted and combined to create a user similarity factor (‘St,i’) between the target user and each other user. Example difference factors include geographic distance between the two users, how many years (or how many age range bands) separate their ages, etc.
   Similarity factors may be calculated differently by using different emphasis factors (‘E’), depending on the types of items CollabView is asked to recommend. For example, in recommending a movie, the system may assign a higher emphasis factor to age than to geographic location, or the system might assign a higher emphasis factor to geographic location when recommending political news.

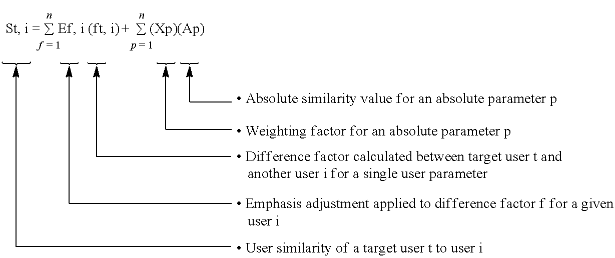

Cohorts may be defined arbitrarily. CollabView users may specify Cohorts, based on available user parameters, and have the CollabView system filter items based on the preferences of those specified Cohorts.
   A simple Cohort example would be one designed by a user to identify sports stories most relevant to Pittsburgh residents, 28-34 years old. Once the user has defined the Cohort, CollabView would identify Cohort members by calculating which users were most similar, based on location and defined age bracket only, and might calculate Cohort membership either based on a value threshold for ‘S’, a specified number of users with the highest ‘S’ values, or on some combination of these factors.
   To create Cohorts for filtering items a user may only be able to use those parameters for which he has supplied personal information about himself.
Cohorts may be defined in some cases to eliminate all users who do not share a specific parameter value exactly, or to include all users who do share that parameter value.
   For example: If a target user is male, 25-years-old, and living in Baltimore, a formula based on relative factors only might not recommend entertainment news preferred by a 35-year-old, male living in New York City. However, a formula that includes calculations for absolute parameters might recommend each user's preferred content to the other if both users identify themselves as filmmakers and graduates of Wesleyan University.
   Where a Cohort is specified such that absolute parameters are to be used restrictively, CollabView will remove from the Cohort all users whose user profiles do not include the specified absolute parameters. The remaining users in the Cohort may still have their preferences weighted by relative user similarity in calculating content recommendation weights.
   It is important to note that users may belong to many overlapping Cohorts.
Cohorts may be defined to give more weight to specific parameters. For example, CollabView and its partners may use emphasis factors to weigh certain user parameters more highly than other parameters for certain applications.
In some cases, Cohorts may be determined according to similar content preferences between users according to Pearson's coefficient or other existing algorithms for item-based collaborative filtering.

### How CollabView Gathers Information

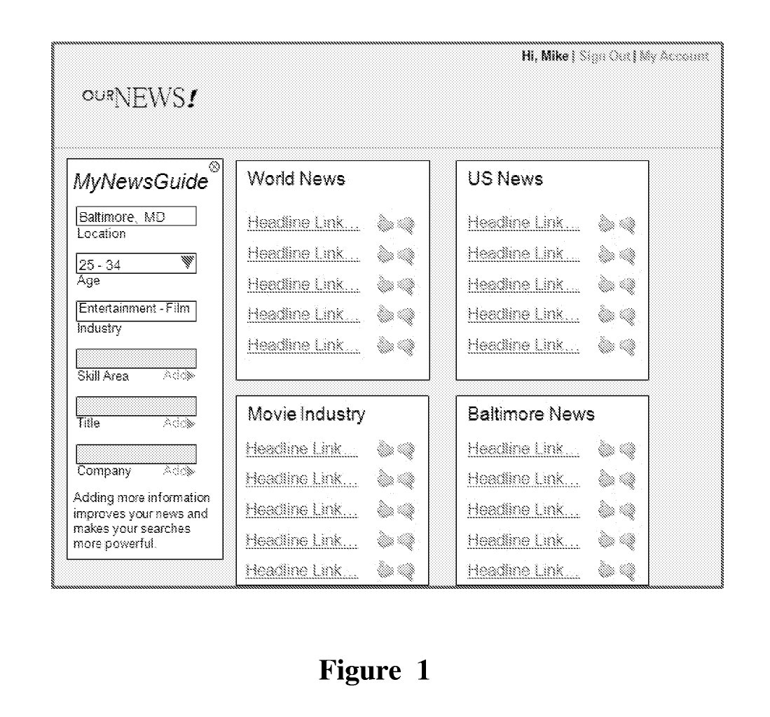

The CollabView uses the following types of information:
   Data about users, to build user Cohorts and weight user preferences.
   Data about user preferences.
   Data about items to be analyzed for recommendation to users.
   Data to structure item recommendations (cohort definitions, parameter emphasis, etc.).
   Data to configure the system.
   Other data, as necessary.
CollabView incorporates the following information about users:
   Data to identify users along demographic, psychographic, biological, or other parameters. Examples of these parameters include age, gender, postal code, level of education achieved, schools attended or graduated, industries worked in, job titles held, group affiliation, biological traits, etc.
   Data about user preferences for specific items. These preferences can be expressed through a number of user behaviors, including item purchases, votes or recommendations, comments, referrals, downloads, printing, saving or recording, or other activities indicating interest in an item.
   Other information to help CollabView predict user preferences more accurately. One example of such other information would be emphasis factors that will improve CollabView's recommendations and aggregated data products.
CollabView may collect user information in any number of ways, including direct user input, access to user information through partners, inference from incomplete user information, etc.
CollabView may augment user-supplied information by comparing that information with data available from other sources, including census data, other web sites, or other stores of relevant information. Where external data stores can be matched positively with a user identity (for example, through a unique identifier such as an email address), the additional information may be deemed reliable and explicit. Where external information cannot be matched to an individual user, it may still be relevant as inferred user data. Explicit information supplied by users will usually replace inferred user data.
Users may add additional information as they use a CollabView-enabled web site. As an example, the MyNewsGuide box (or other similar feature) may appear on any CollabView-enabled web site as one means of collecting additional information while making clear the user benefits of providing such information.
   FIG. 1 shows an example of a GUI whereby a user may filter his or her news by location, age range, and industry affiliations of other users, but the user must add information about his or her skill area, job title, and company to filter based on these additional parameters. (This is an example of business logic implemented to encourage information disclosure—actual user parameters may vary among implementations.)
CollabView-enabled web sites track relevant user activities. For example, an online news site enabled by CollabView might track how users rate news stories (e.g., a star rating, as appears on Yahoo! news sites); which stories a user reads, and how long they spend reading the stories; to which news categories a user give the most attention; which authors a user rates highly; which stories a user comments on (and what words they have used in their comments); and which stories a user forwards to others.
   User preference behavior in the above example is collected through ‘thumbs up’ and ‘thumbs down’ rating system.).
   It does not matter whether CollabView collects information about user behavior directly, or whether that information is supplied by a partner.
CollabView will collect and compare metadata from items in each item universe. Metadata can be used for, among other things, item-based collaborative filtering, to predict user interest in items too new or too obscure to have been the target of user preference behaviors. For example, if a user Cohort has expressed interest in the journalist Carolyn Lochhead's articles for the San Francisco Chronicle, the CollabView system may recommend a new article of hers as soon as it is published, instead of waiting for it to accumulate high ratings, referrals, or other positive behaviors. Note that existing collaborative filtering systems might define a Cohort by users' shared interest in Carolyn Lochhead, the San Francisco Chronicle, or political news—CollabView would still define the Cohort in terms of user attributes, and so would recommend Ms. Lochhead's articles to a different set of people than would an existing collaborative filtering system.
CollabView may be implemented as part of a stand-alone site, as a service provided to other web sites, or as a combination. (An example of such a combination might be a news web site that licenses CollabView technology for configuration as an independently operated system. Such news site may also augment the user data they collect through their independent system with other data aggregated by CollabView from other sources).
For any type of implementation, a CollabView-enabled system may gather user information from business partners or other sources. This information may be gathered as part of a service agreement, purchased, or otherwise gathered from available sources.
In general, CollabView asks individual users to input information about them, so that the system can generate accurate recommendations for similar users.

### How Item Universes are Defined

Items are whatever users might be interested in, and they can be defined in almost any manner.
   Items may be text, media (photographs, graphics, audio, video, etc.), links referring to any sort of physical item (including other users), URIs/URLs, or any sort of information. Items may come from any source, including user-generated content.
Item universes may be defined for users (e.g., by a company operating a web site), or they may be defined by a user.
   Users may create restricted item universes (e.g., a user selects a set of news sources—New York Times, Financial Times, and Rolling Stone Magazine; or a user searches for wristwatches on a retailer's web site) to be further filtered by CollabView.
   A user may also define item categories in various ways (for example, by a key word, such as a sports team name; or by a category, such as sports news) for RSS feeds, a customized web page, a search result, or any variety of content presentations.

### How User Preferences are Calculated

CollabView calculates an individual user's overall preference (‘P’) for a specific item (‘j’) by aggregating that user's preference behaviors (‘V’—for “votes”), adjusted for the user's typical voting pattern (‘V’ with a bar over it), with each preference behavior weighted by a weighting factor (‘W’).
Preference behaviors can include purchasing, rating, commenting on, referring other users to, or other activities indicating interest in an item. In many cases, a user will execute several preference behaviors for a single item. For example, a user may purchase a kitchen appliance, then rate with five stars on the vendor's web site, and also refer a friend to it by sending a referral email directly from the vendor's web site. CollabView would be able to track all of those activities if the vendor had enabled CollabView's technology. It is relevant that some user behavior will not be tracked by CollabView, and that the design of each site implementation can have a significant effect on how much information CollabView can gather.
Preference weighting factors may vary between types of content (e.g., referring a news story to a friend may be weighted more highly than giving the story a high rating, but rating a kitchen appliance may be more heavily weighted than referring it to a friend.), and between CollabView implementations.
An individual user's preference for a specific item may be calculated as follows:

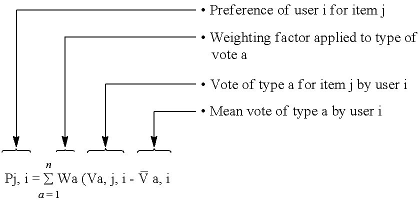

### How CollabView Recommends Items

CollabView recommends items to target users by first determining which items in the item universe are relevant to a user's request.
   Relevant items are subsets of all available items, where the subsets are defined by such factors as category relevance (e.g., whether the user has asked to see US news or entertainment news) and “freshness” (a definition that will depend on, among other things, an item's type. For example, “freshness” for a product might mean that it is still being manufactured, but for breaking news, “freshness” might be defined as being published within the last hour).
   CollabView may substitute other measures of user relevance where user preference information is inadequate. For example, there may not be adequate Cohort preference information available to recommend items of breaking news so “freshness” (‘Q’) may be weighted more highly than Cohort preferences.
CollabView then ranks all relevant items according to a recommendation value (‘R’) that is based on an aggregation of other users' preferences (‘P’) for that item weighted by the similarity between (‘S’) each user and the target user.
   Note that CollabView may not calculate a recommendation based on all users, but will be able to determine a relevant subset of users by setting a threshold value for ‘S’.
   Similarly, for efficiency, relevant items with very low ‘P’ values may not be considered.

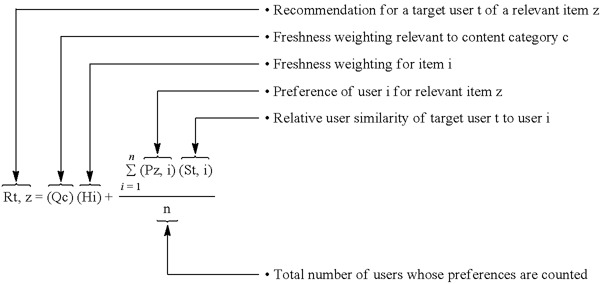

The above formula is one example of how this might be done. It is provided as an example to demonstrate one solution, and may be adjusted for specific implementations.
CollabView may make recommendations based on correlations between item metadata. This would, among other things, allow the system to recommend very recent or obscure items that have not yet received sufficient user exposure.
A functional CollabView system may, for various reasons (business reasons, user interface concerns, etc.), present items other than those that a theoretically optimized system would select. For example a news site might buffer recommendations for certain periods (not present a new set of headline links with each page refresh), since real-time item rankings would be computationally expensive and might upset a user who expects a more consistent experience.

### How CollabView's Recommendations are Displayed

Recommendations may be displayed electronically (e.g., as a web page, an RSS feed, a photo collection, etc.), in print form (e.g., a printed newspaper or magazine, direct mail, etc.), audibly, or by other means.
   For example, CollabView may be used to create a customized view of an online newspaper, or it may be used to create news channels (e.g., as RSS feeds) for inclusion in other news applications (e.g., MyYahoo!, etc.).

### Shadow Cohorts

The system allows the user to be able to create one or more profiles for groups that they want to shadow.
   For example, CollabView may be used to create a plurality of shadow Cohorts for specific user interests. A first shadow Cohort may be directed toward music 25-year-olds living in San Fran are listening to, while a second shadow Cohort may be directed to what news 50-year-old anthropologists are reading.
   In a preferred embodiment, content will be presented in such a way as to identify which Cohort it has been selected for and the relevancy of it within that Cohort.

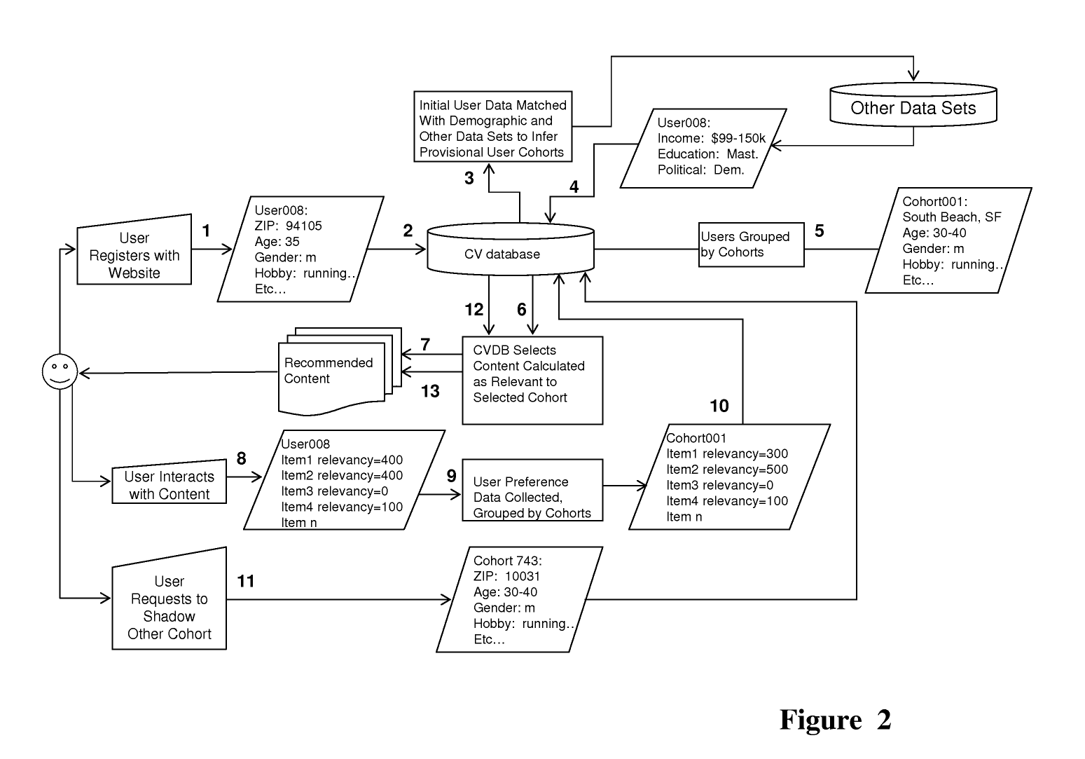

Referring to FIG. 2, a flow chart illustrating the method of use of the CollabView System is shown. The system my be implemented on a website and uses a software engine to perform the various steps of the process described below.

Step 1: A User Registers with the CollabView Website. During the registration process, the user fills out a data capture form to be able to register. The data will embody their Profile on the website, which Profile the user will maintain and can change or add to. The data capture form will request basic demographic information about the user: Zip Code, Age (in banded ranges), Gender, Hobbies, Affiliations, etc.

Step 2: The User Profile data is stored in the CollabView database (CVDB). In the database, all user attributes and preference data are stored. The content is ranked based on relevance to each Cohort.

Step 3: The User Profile can be matched to data service offerings that access other data sets in order to infer supplementary information about the user. For example, Zip Code and age may be used to infer income, some overall score of affluence, or other parameters.

Step 4: Any additional information provided is added to the user's profile in the CVDB as ‘inferred data points’. These data points are differentiated in order to keep track of user-provided versus non-user-provided data for scoring and profile maintenance.

Step 5: Users are grouped into Cohorts based upon statistically significant numbers of similarities between user communities.

Step 6: The software engine selects content from the CVDB to present to the user derived from the user's Cohort. This is done by finding what other members of that Cohort rank as highly relevant to them. All of the content viewed by a Cohort is ranked by the number of positive ratings by members in that Cohort. The content is also weighted and scored based upon those most similar to the user within the Cohort. This helps determine the relevancy ranking when presenting the content to each individual in the Cohort.

Additional Content can be served. This is in the cases of new or obscure content that CollabView might have meta-data about to determine if it would be relevant to a user in a certain Cohort.

Step 7: Once the software engine finds recommended content in the CVDB, that content can be presented to the user on the website. Content will be presented sorted by relevance, grouped by categories (news, products, events, ‘local’, sports, etc.), or according to specifications of the user and other criteria.

Step 8: In a preferred embodiment, a user may view each item of content and rank it as being relevant or not relevant. This can be done by a simple ‘thumbs up’ or ‘thumbs down’, or, in order to get more detailed information, by a rating system with feedback as to topic. CollabView may also track and record a range of other preference behaviors.

Step 9: The user preferences for each item are aggregated. In a preferred embodiment, all users' ratings will count only within their own user Cohort(s), and not to the preferences of Cohorts that they may be shadowing.

Step 10: The item rankings are stored in the CVDB and linked with the user's personal (cohort-related) parameters to drive cohort-specific recommendations.

Step 11: In some embodiments, a user can also choose to see what other Cohorts are seeing. This is called Cohort ‘shadowing’, which means viewing content recommended as relevant to a Cohort other than their own Cohort. Such shadow profile generation uses a data-form similar to the one used when capturing their own profile information. The user would enter information about the group of people they want to learn more about or learn what they are seeing; where they are located, their age, gender, hobbies and more.

Step 12: The software engine uses that information to find a Cohort of users whose individual parameters most closely match the defined Shadow Cohort. The software engine identifies content in the CVDB preferred by the users in the Shadow Cohort to present to the requesting user. The content should be the same content that would be presented to that Shadow Cohort. That is, the software engine selects content recommended for the Shadow Cohort defined by the user.

Step 13: Once the software engine finds recommended content in the CVDB based on the shadow profile, the Shadow Cohort recommendations are presented to the user.

In a preferred embodiment, content will be presented in such a way as to identify which Cohort it has been selected for and the relevancy of it within that Cohort. All users' ratings are linked to specific user parameters—they cannot influence the recommendations of user Cohorts when they share no user parameters with these Cohorts. So, if an item from a Shadow Cohort is rated, that item and its rating are attributed back to the user's own Cohorts, not the Shadow Cohort.

Some of the specific, unique features of the invention are described below.

A. CollabView groups users by shared demographic or other personal characteristics, and then identifies prevalent preferences within these groups (Cohorts). Existing collaborative filtering systems group people according to their shared preferences. Only CollabView can compare who users say they are with what these users actually prefer.

B. CollabView lets a user select user Cohorts of interest to him or her, and then see which items are preferred by those user Cohorts, even if the user is not a member of a selected Cohort. For example, a San Francisco-based financial journalist in his mid-30's could see items calculated as relevant to 55-year-old, New York-based, Wharton MBAs who work in the insurance industry. Existing systems only permit users see the preferences of other users who have already expressed similar preferences. CollabView lets users see what is preferred by people they hope to be like, need to do business with, or want to understand for other reasons.

C. CollabView lets users select which of filtering parameters (cohort attributes, item ‘freshness’, etc.) are most significant to them, allowing them to further ‘tune’ which items are recommended to them.

D. CollabView creates a unique incentive for users to disclose personal information about themselves. The proposition where a user gains more specific control over how information is filtered with each bit of new personal information he discloses, appears to have no precedent.

The system of the present invention can be implemented as a stand-alone CollabView news site. In some embodiments, the system of the present invention can be linked to or featured with existing websites, such as social networking sites.

The system of the present invention will make content recommendations to specific users using a combination of collaborative filtering and content filtering methods that aggregate individual users into any number of statistically significant subgroups, or Cohorts, based on users' demographic, psychographic, or other information.
1. The CollabView system recommends various types of items (including web content, products, services, people, etc.) to individual users based on the aggregated preferences of specific groups of users (“Cohorts”), where these groups are defined by their shared or similar demographic, psychographic, biological, or other parameters.
2. The system provides a unique incentive for users to disclose accurate personal information.
3. The system uses a combination of user-based and item-based collaborative filtering methods to aggregate individual users into any number of statistically significant Cohorts.
4. The system tracks user behaviors (ratings, use of site content, sharing of site content, etc.) to measure users' preferences towards specific content items, and aggregates these user preferences by user Cohort to calculate content's relevance for other members of each Cohort.
5. The system presents relevance-ranked lists of items to individual users according to users' membership in specific Cohorts, and according to users' interest in seeing items relevant to specific Cohorts other than those in which they are members.
6. The system can work with other systems that track user behaviors and collaboratively filter items.
7. The system will aggregate and display commercially valuable, near-real-time information about user preferences and attitudes, sorted according to standard demographic and other user categories employed by marketers, research organizations, and others, without compromising individual privacy.

It will be appreciated by persons skilled in the art that numerous variations and/or modifications may be made to the invention as shown in the specific embodiments without departing from the spirit or scope of the invention as broadly described. Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It should be understood, therefore, that the invention might be practiced otherwise than as specifically set forth herein. The present embodiments are, therefore, to be considered in all respects as illustrative and not restrictive.

What is claimed is:

1. A method for recommending content items to users, the method comprising:
providing a database;
providing an address accessible to at least one user, via a computer system, for interactive communications between said at least one user and said database;
providing an interface to enable a plurality of individuals to supply demographic, psychographic, and other information about themselves;
collecting records of demographic, psychographic, and other information about a plurality of individuals into said database;
collecting behavioral information about users, including their preferences for or against arbitrarily defined sets of items;
creating, in the database, a profile for each user;
calculating aggregate similarity between individuals according to aggregated similarity of weighted measures of arbitrarily selected demographic, psychographic, or other individual attributes;
identifying a plurality of items to be evaluated for recommendation to users;
generating item preference scores to measure individuals' attitudes toward, or preferences for, the items or item metadata based on a dataset of user selections;
defining user Cohorts according to calculated aggregate similarities between individuals;
calculating content relevance to individual users or user Cohorts;
generating Cohort-specific item recommendation scores by aggregating item preference scores of the individuals in a Cohort;
selecting items for display to users according to cohort-specific recommendation scores; and
displaying a list of items selected according to cohort-specific recommendation scores.

2. The method of claim 1, further comprising:
collecting item data and metadata from external data sources; and
displaying items, item data, and metadata according to cohort-specific recommendation scores.

3. The method of claim 1, wherein system users provide specific types of personal information before being allowed to define cohorts according to those types of information.

4. The method of claim 1, wherein individuals' attributes may be used inclusively or exclusively in defining cohorts.

5. The method of claim 1, wherein a user may select how specific individual attributes are weighted in calculating similarity between individuals.

6. The method of claim 5, wherein specific individual attributes are weighted arbitrarily in calculating similarity between individuals.

7. The method of claim 1 wherein similarity of individual user attributes is defined absolutely.

8. The method of claim 1 wherein similarity of individual user attributes is defined relatively.

9. The method of claim 1, wherein types of user behaviors are weighted arbitrarily in calculating item preference scores.

10. The method of claim 1, wherein item recommendation scores are generated for items for which insufficient individual preference data exists, according to similarities in item data or metadata.

11. The method of claim 1, further comprising:
allowing a user to select or design user cohorts arbitrarily.

12. The method of claim 1, wherein users are grouped into Cohorts based upon statistically significant numbers of similarities between user communities.

13. The method of claim 1, wherein items are presented to users for viewing sorted by relevance.

14. The method of claim 1, wherein items are presented to users for viewing sorted by category.

15. The method of claim 1, wherein items are presented to users for viewing sorted by user specification.

16. The method of claim 1 further comprising:
providing an incentive system to encourage disclosure of personal information by users.

17. The method of claim 1, further comprising:
allowing a user to create a profile of at least one Cohort group for shadowing;
selecting items for display to the users according to the defined shadow Cohort; and
displaying a list of items selected according to the Shadow Cohort-specific recommendation scores.

18. The method of claim 17, wherein items are presented in such a way as to identify which Cohort it has been selected for and the relevancy of it within that Cohort.

19. The method of claim 17, wherein the user ratings cannot influence the recommendations of user Cohorts when they share no user parameters with these Cohorts.

20. The method of claim 19, wherein an item rated from a Shadow Cohort is attributed back to the user's own Cohorts.
